(19) United States
(12) Patent Application Publication
(10) Pub. No.: US 2017/0105384 A1
(43) Pub. Date: Apr. 20, 2017

(54) AUTOMATIC LITTER AND WASTE SEPARATOR DEVICE

(71) Applicant: Ronald S. Waters, Austin, TX (US)

(72) Inventor: Ronald S. Waters, Austin, TX (US)

(21) Appl. No.: 15/294,758

(22) Filed: Oct. 16, 2016

Related U.S. Application Data
(60) Provisional application No. 62/243,006, filed on Oct. 17, 2015.

(51) Int. Cl. A01K 1/01

(52) U.S. Cl. CPC A01K 1/0114

(57) ABSTRACT

In some embodiments, an automatic litter and waste separator device may include a litter container which may have a base and one or more sidewalls. The base and sidewalls may form a cavity which may contain a volume of litter media and the like. A litter motivator may be coupled to the litter container and the litter motivator may be configured to vibrate or otherwise motivate the contents of the cavity. Optionally, a horizontal dampener may be coupled to the litter container and the horizontal dampener may vibrationally isolate and separate the litter container and the litter motivator above a floor surface. Optionally, a vertical dampener may be coupled to the litter container and the vertical dampener may vibrationally isolate and separate the litter container and the litter motivator above a floor surface.

### CROSS REFERENCE TO RELATED APPLICATIONS

This application claims priority to and the benefit of the filing date of U.S. Provisional Application No. 62/243,006, filed on Oct. 17, 2015, entitled “Cat or Other Animal Litter Box with Automatic Waste Separator for Easy Clump removal, Dust Suppression and Litter Leveling”, which is hereby incorporated by reference in its entirety.

### FIELD OF THE INVENTION

This patent specification relates to the field of devices for the manipulation of animal waste. More specifically, this patent specification relates to a device which is configured to separate animal waste and dust from litter and other animal waste receiving media.

### BACKGROUND

In animal litter boxes, separating the animal waste and debris, such as feces and urine clumps, from the litter matrix or animal waste receiving media involves digging through the litter to discover and remove the animal waste and debris. This is a messy process and frequently causes dust to be raised from the litter.

Some existing advanced litter box designs typically have some form of raking system in order to collect the waste and debris. Other advanced litter boxes have rotating or other moving parts that are prone to break. When these advanced litter boxes are used the moving parts tend to stir up dust that spreads throughout the room. Because of the complexity, the advanced litter boxes also tend to be costly and large. Simple litter boxes, or simple litter containers, do not have any method to separate waste and debris from litter and the litter must be manually dug through with a scoop to locate and remove the waste and debris clumps.

While all litter boxes are functional, they either involve digging through litter to locate debris or are costly and complex systems to isolate the debris. In both cases, they stir up litter dust. This dust is not only unsightly, but can result in health problem to human and animals as many pathogens can be carried by the dust.

Therefore, a need exists for novel devices for the manipulation of animal waste. There is a further need for novel animal waste manipulation devices that do not require the use of moving parts that are expensive and prone to break. Finally, there exists a need for novel animal waste manipulation devices that reduce or eliminate the escape of litter dust from the devices.

### BRIEF SUMMARY OF THE INVENTION

An automatic litter and waste separator device is provided. In some embodiments, the device may include a litter container which may have a base and one or more sidewalls. The base and sidewalls may form a cavity which may contain a volume of litter media and the like. A litter motivator may be coupled to the litter container and the litter motivator may be configured to vibrate or otherwise motivate the contents of the cavity. A horizontal dampener may be coupled to the litter container, such as to the base of the litter container, and the horizontal dampener may support the litter container and the litter motivator above a floor surface thereby vibrationally isolating and separating the litter container and the litter motivator from the floor surface.

In further embodiments, the device may comprise a vertical dampener which may be coupled to the litter container, such as to one or more sidewalls of the litter container, and the vertical dampener may also be coupled to the horizontal dampener.

In alternative embodiments, the device may include a litter container which may have a base and one or more sidewalls. The base and sidewalls may form a cavity which may contain a volume of litter media and the like. A litter motivator may be coupled to the litter container and the litter motivator may be configured to vibrate or otherwise motivate the contents of the cavity. A vertical dampener may be coupled to the litter container, such as to one or more sidewalls of the litter container, and the vertical dampener may support the litter container and the litter motivator above a floor surface thereby vibrationally isolating and separating the litter container and the litter motivator from the floor surface.

In further embodiments, the device may comprise a horizontal dampener which may be coupled to the litter container, such as to the base of the litter container and/or to a litter motivator, and the horizontal dampener may also be coupled to the vertical dampener.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of an automatic litter and waste separator device according to various embodiments described herein.

FIG. 2 illustrates a sectional, through line A-A shown in FIG. 1, elevation view of an example of an automatic litter and waste separator device according to various embodiments described herein.

FIG. 3 shows a perspective view of another example of an automatic litter and waste separator device according to various embodiments described herein.

FIG. 4 depicts a sectional, through line 4-4 shown in FIG. 3, elevation view of another example of an automatic litter and waste separator device according to various embodiments described herein.

FIG. 5 illustrates a perspective view of a further example of an automatic litter and waste separator device according to various embodiments described herein.

FIG. 6 shows a sectional, through line 6-6 shown in FIG. 5, elevation view of a further example of an automatic litter and waste separator device according to various embodiments described herein.

FIG. 7 depicts a perspective view of still another example of an automatic litter and waste separator device according to various embodiments described herein.

FIG. 8 illustrates a sectional, through line 8-8 shown in FIG. 7, elevation view of still another example of an automatic litter and waste separator device according to various embodiments described herein.

FIG. 9 shows a sectional, through line A-A shown in FIG. 1, elevation view of an example of a litter container of an automatic litter and waste separator device according to various embodiments described herein.

FIG. 10 depicts a block diagram showing some of the elements of an exemplary automatic litter and waste separator device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

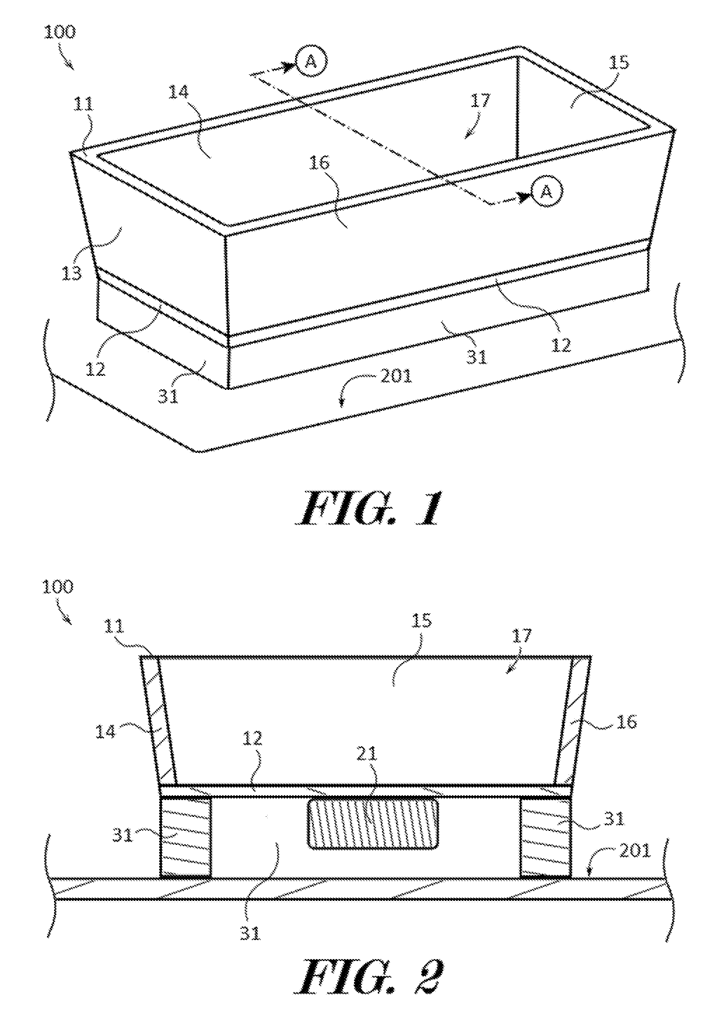

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

New devices for the manipulation of animal waste are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

The present invention will now be described by example and through referencing the appended figures representing preferred and alternative embodiments. FIGS. 1 and 2 illustrate an example of an automatic litter and waste separator device (“the device”) 100 according to various embodiments. In this example, the device 100 comprises a litter container 11 which may include a base 12 (FIG. 2) and one or more sidewalls 13, 14, 15, 16. The base 12 and sidewalls 13, 14, 15, 16, may form a cavity 17 which may contain a volume of litter media and the like. A litter motivator 21 (FIG. 2) may be coupled to the litter container 11 and the litter motivator 21 may be configured to vibrate or otherwise motivate the contents of the cavity 17. A horizontal dampener 31 may be coupled to the litter container 11, and the horizontal dampener 31 may support the litter container 11 and the litter motivator 21 above a floor surface 201 (FIGS. 1-4) thereby separating the litter container 11 and the litter motivator 21 from the floor surface 201.

Turning now to FIGS. 1-8, a litter container 11 may comprise a container having a cavity 17 which is able to receive a volume of litter media. In some embodiments, a litter container 11 may be formed by one or more, such as four, sidewalls 13, 14, 15, 16, and a base 12. The base 12 may be coupled to the sidewalls 13, 14, 15, 16, each of which may extend up and away from the base 12. The sidewalls 13, 14, 15, 16, may each be coupled to two other sidewalls 13, 14, 15, 16, to form a generally rectangular prism shaped container which may define the cavity 17 for receiving a volume of litter.

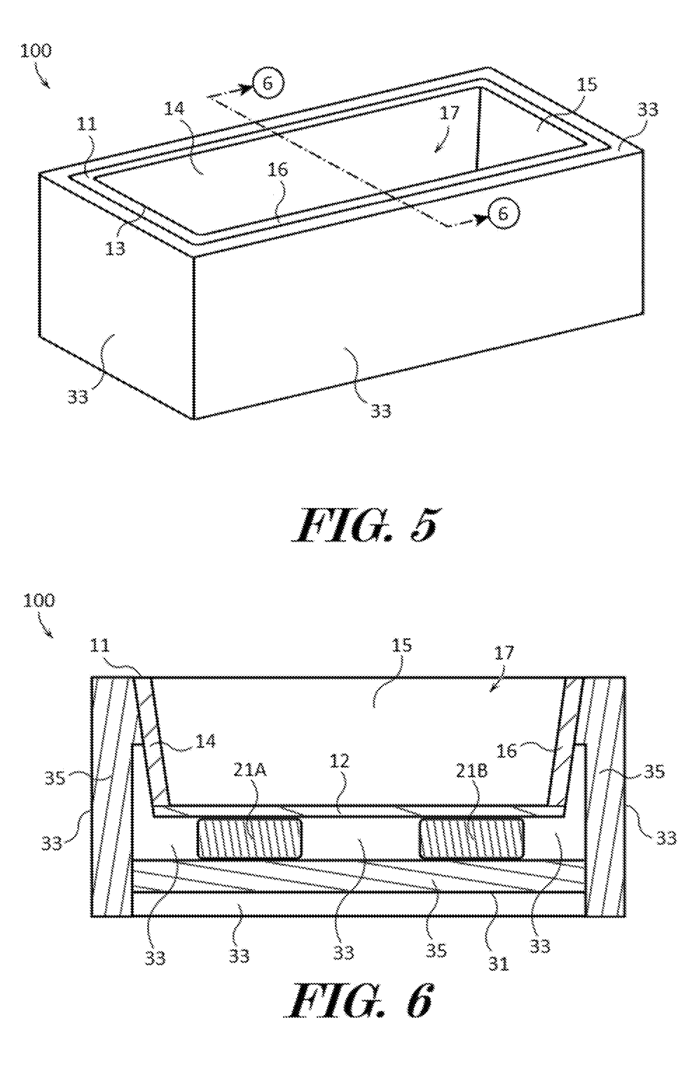

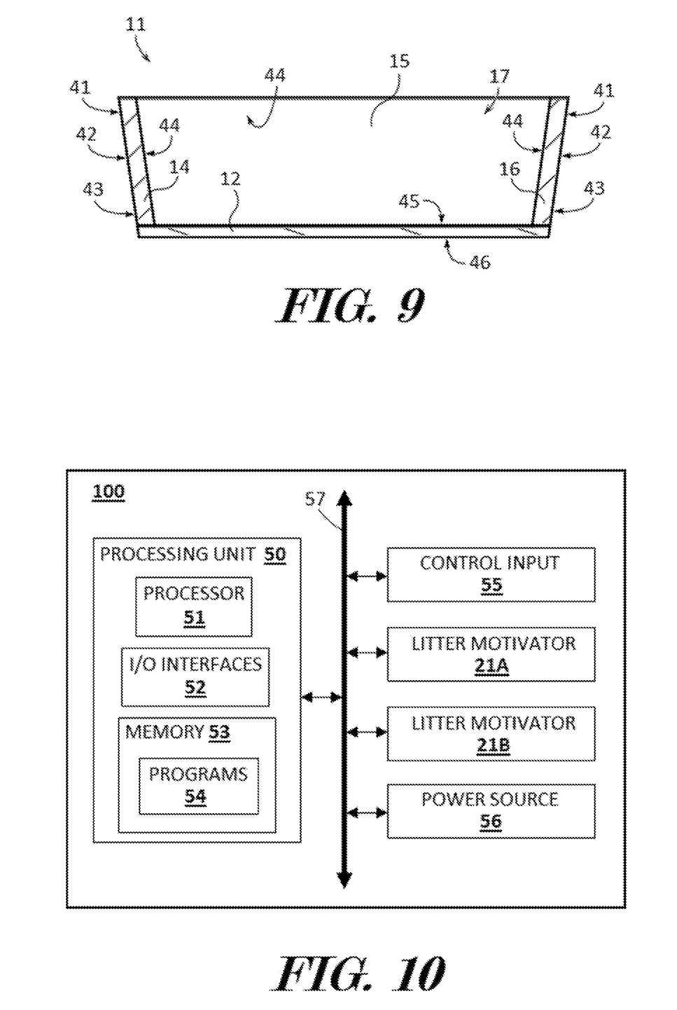

As perhaps best shown in FIG. 9, each sidewall 13, 14, 15, 16, may comprise an upper exterior surface 41, a middle exterior surface 42, and a lower exterior surface 43. The upper surface region 41 may comprise approximately one third of the length of the exterior surface of a sidewall 13, 14, 15, 16, that is farthest from the base 12. The lower exterior surface 43 may comprise approximately one third of the length of the exterior surface of a sidewall 13, 14, 15, 16, that is closest to and/or coupled to the base 12. The middle exterior surface 42 may comprise approximately one third of the length of the exterior surface of a sidewall 13, 14, 15, 16, that is between the upper exterior surface 41 and the lower exterior surface 43. In some embodiments, and as shown in FIGS. 4 and 6, one or more vertical dampeners 33 may be coupled to the upper exterior surface 41 and portions of the middle exterior surface 42. In further embodiments, and as shown in FIG. 8, one or more vertical dampeners 33 may be coupled to the upper exterior surface 41, middle exterior surface 42, and lower exterior surface 43. In alternative embodiments, one or more vertical dampeners 33 may be coupled to the upper exterior surface 41, to the middle exterior surface 42, and/or to the lower exterior surface 43.

Also as perhaps best shown in FIG. 9, each side sidewall 13, 14, 15, 16, may comprise a sidewall interior surface 44 which may form portions of the cavity 17 and which may contact litter media within the cavity 17. Similarly, the base 12 may comprise a base interior surface 45 which may also form portions of the cavity 17 and which may also contact litter media within the cavity 17. The base 12 may also comprise a base exterior surface 46 which may be coupled to a horizontal dampener 31 and/or a litter motivator 21.

It should be understood that one or more sidewalls 13, 14, 15, 16, and/or the base 12 may optionally be integrally formed together as a single unit. Preferably, litter container 11 may be made from or comprise rigid materials, such as plastics, resins, metals, metal alloys, and the like. It should be understood to one of ordinary skill in the art that the sidewalls 13, 14, 15, 16, and base 19 may be configured in a plurality of sizes and shapes to form any shaped litter container 11 and cavity 17 including cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

One or more litter motivators 21 may be vibrationally coupled to the litter container 11. A litter motivator 21 may be configured to vibrate, shake, or produce any other series of rapid and repeated movements. In some embodiments, a litter motivator 21 may be vibrationally coupled to the litter reservoir 11 by being directly coupled to a portion of the litter reservoir 11, such as to the base 12 and/or to one or more sidewalls 13, 14, 15, 16, so that vibrations from the litter motivator 21 may be transferred from the litter motivator 21 through the litter container 11 thereby vibrating or otherwise agitating the contents within the cavity 17. In other embodiments, a litter motivator 21 may be vibrationally coupled to the litter container 11 by being coupled to any element of the device 100 so that vibrations from the litter motivator 21 may be transferred from the litter motivator 21 through the device 100 to the litter container 11 thereby vibrating or otherwise agitating the contents within the cavity 17. A litter motivator 21 may comprise a long life brushless (BLDC) vibration motor, a coin or pancake vibration motor, an encapsulated vibration motor, an enclosed vibration motor, a pager motor, an eccentric rotating mass (ERM) motor, a linear resonant actuator (LRA), a printed circuit board (PCB) mounted vibration motor, a switching electro-magnet, or any other electrical device capable of producing a series of rapid and repeated movements.

By vibrating or otherwise agitating the contents of the cavity 17, the device 100 may perform one or more functions. First, vibrating the contents of the cavity 17 causes any dust in the litter media to settle towards the base 12 of the litter container 11, below the litter media matrix. Second, vibrating the contents of the cavity 17 causes the animal waste and debris, such as feces and urine clumps, to “float” to the surface of the litter media matrix for easy removal. Third, vibrating the contents of the cavity 17 may level the surface of the litter media in preparation for the next use. These functions may be accomplished through the principle of Granular Convection, commonly referred to as the “Brazil Nut Effect”, to automatically separate animal waste from a matrix of normal litter media granules. This is accomplished by agitating or vibrating the litter media and contents of the cavity 17. The granular convection principle causes the larger clumps of animal waste to rise to the surface and sit on top of the surface of the litter media. Once there, they are more easily removed as opposed to digging through the matrix of litter and locating and removing the debris. An additional benefit of vibrating the litter matrix is that it tends to separate the dust in the litter and cause it to drop to the bottom of the litter box, below the useable litter material. Because of this separation of dust at the bottom, litter material in the middle and the debris surfaced on top of the litter material, dust is minimized.

In some embodiments, the device 100 may comprise a single litter motivator 21 which may be coupled to the base 12, such as centrally, below the cavity 17. In further embodiments, the device 100 may comprise a first litter motivator 21A (FIGS. 4, 6, 8, and 9), a second litter motivator 21B (FIGS. 4, 6, 8, and 9), a third litter motivator, a fourth litter motivator, a fifth litter motivator, a sixth litter motivator, or more, such as a plurality, of litter motivators 21 which may be coupled anywhere to the base 12 and/or coupled to any other element of the device 100. Through strategic placement of the litter motivators 21 and adjustment of their vibrating strength, it is possible to generate convection currents in order to raise debris to the surface of litter media within the cavity 17, and to also direct movement of the debris, once surfaced, to behave in a proscribed manner. For example, a first litter motivator 21A coupled below the base 12 may vibrate to raise the raise waste and debris to the surface of litter media within the cavity 17, while a second litter motivator 21B coupled to a sidewall 13, 14, 15, 16, may vibrate to motivate the debris towards or away from the second litter motivator 21B and its respective sidewall 13, 14, 15, 16.

In some embodiments, and as shown in FIGS. 1, 2, and 5-8, the device 100 may comprise one or more horizontal dampeners 31. A horizontal dampener 31 may support a litter motivator 21 and/or the litter container 11 above a floor surface 201 (FIGS. 1-4) while also providing vibrational isolation between the floor surface 201 and the litter motivator 21 and/or the litter container 11. In preferred embodiments, one or more horizontal dampeners 31 may be coupled to the base 12 of the litter container 11 and may physically separate the base 12 from the floor surface 201 (FIGS. 1-4) which is supporting the device 100. In further preferred embodiments, one or more horizontal dampeners 31 may be coupled to a litter motivator 21 that is coupled to the base 12 of the litter container 11, and the one or more horizontal dampeners 31 may physically separate the litter motivator 21 that is coupled to the base 12 from the floor surface 201 (FIGS. 1-4) which is supporting the device 100. In some embodiments, a horizontal dampener 31 may be formed by a single dampening material 35 (FIG. 6). In other embodiments, one or more dampening materials 35 may be integrally formed or otherwise coupled together to form a horizontal dampener 31.

In some embodiments, a horizontal dampener 31 may comprise a generally flat planar rectangular prism shape, similar to a flattened cuboid shape which may be open on two opposing sides, with the base 12 being coupled to the horizontal dampener 31 so that the one or more litter motivators 21 may be isolated or prevented from contacting a floor surface 201 (FIGS. 1-4) upon which the device 100 is placed. In further embodiments, one or more horizontal dampeners 31 may be shaped to contact all or portions of the base 12 so that the base 12 and any litter motivator 21 that is coupled to the base 12 may be supported and/or vibrationally isolated by the two or more horizontal dampeners 31.

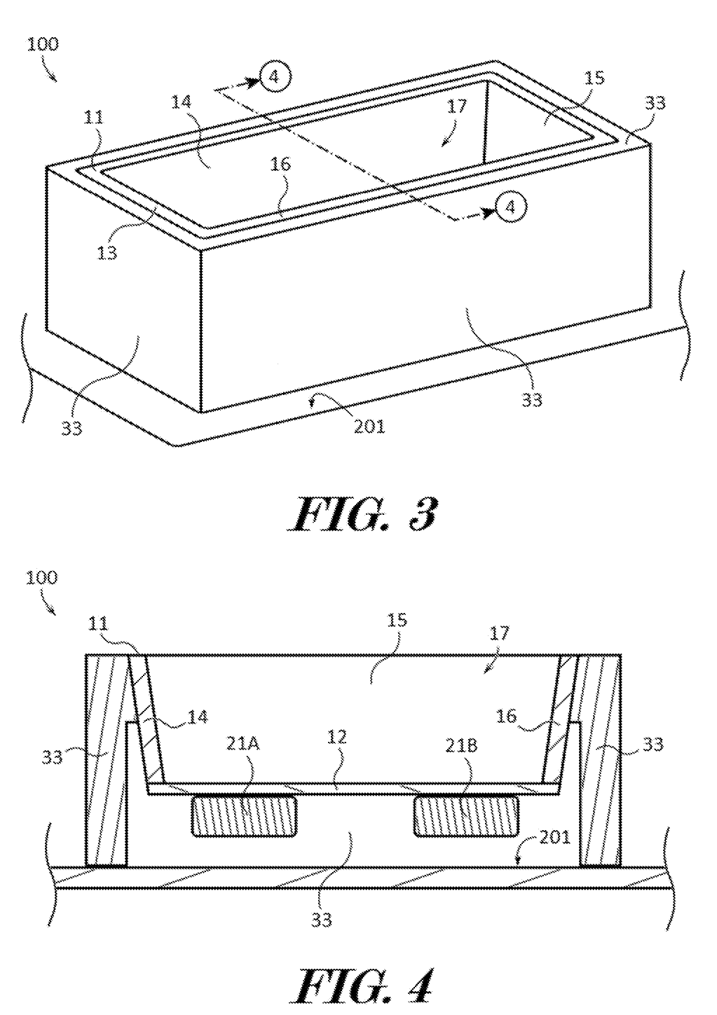

In some embodiments, and as shown in FIGS. 3-8, the device 100 may comprise one or more vertical dampeners 33. A vertical dampener 33 may be coupled to one or more sidewalls 13, 14, 15, 16, and support the one or more sidewalls 13, 14, 15, 16, and therefore the litter container 11 above a floor surface 201 (FIGS. 1-4) while also providing vibrational isolation between the floor surface 201 and the one or more sidewalls 13, 14, 15, 16, and therefore the litter container 11. Optionally, a vertical dampener 33 may be coupled to one or more sidewalls 13, 14, 15, 16, and also coupled to a horizontal dampener 31 so that the vertical dampener 33 support and/or vibrationally isolate the one or more sidewalls 13, 14, 15, 16, from the horizontal dampener 31. In some embodiments, a vertical dampener 33 may be formed by a single dampening material 35 (FIG. 6). In other embodiments, one or more dampening materials 35 may be integrally formed or otherwise coupled together to form a vertical dampener 33.

In some embodiments, a vertical dampener 33 may comprise a generally rectangular shape, similar to a cuboid shape which may be open on two opposing sides, so that each sidewall 13, 14, 15, 16, may be coupled to the vertical dampener 33. In further embodiments, a single vertical dampener 33 may be coupled to two or more, such as to each sidewall 13, 14, 15, 16, so that the two or more sidewalls 13, 14, 15, 16, may be supported and/or vibrationally isolated by the two or more vertical dampeners 33.

A horizontal dampener 31 and a vertical dampener 33 may be made from or comprise a dampening material 35 (FIG. 6), including a combination of dampening materials 35, which may include elastomers, visco-elastic polyurethane materials, rubber, cork, foam materials, laminate materials, and the like. Elastomers may include unsaturated rubbers that can be cured by sulfur vulcanization, such as Natural polyisoprene: cis-1,4-polyisoprene natural rubber (NR) and trans-1,4-polyisoprene gutta-percha; Synthetic polyisoprene (IR for isoprene rubber); Polybutadiene (BR for butadiene rubber); Chloroprene rubber (CR), polychloroprene, Neoprene, Baypren etc.; Butyl rubber (copolymer of isobutylene and isoprene, BR); Halogenated butyl rubbers (chloro butyl rubber: CIIR; bromo butyl rubber: BIIR); Styrene-butadiene Rubber (copolymer of styrene and butadiene, SBR); Nitrile rubber (copolymer of butadiene and acrylonitrile, NBR), also called Buna N rubbers; Hydrogenated Nitrile Rubbers (HNBR) Therban and Zetpol; and the like (Unsaturated rubbers can also be cured by non-sulfur vulcanization if desired), and Elastomers may also include Saturated rubbers that cannot be cured by sulfur vulcanization: EPM (ethylene propylene rubber, a copolymer of ethylene and propylene) and EPDM rubber (ethylene propylene diene rubber, a terpolymer of ethylene, propylene and adiene-component); Epichlorohydrin rubber (ECO); Polyacrylic rubber (ACM, ABR); Silicone rubber (SI, Q, VMQ); Fluorosilicone Rubber (FVMQ); Fluoroelastomers (FKM, and FEPM) Viton, Tecnoflon, Fluorel, Aflas and Dai-El; Perfluoroelastomers (FFKM) Tecnoflon PFR, Kalrez, Chemraz, Perlast; Polyether block amides (PEBA); Chlorosulfonated polyethylene (CSM), (Hypalon); Ethylene-vinyl acetate (EVA); and the like. Foam materials may include silicone foams, rubber foams, urethane foams including ARTiLAGE foams and Poron foams, plastic foams, neoprene foam, latex foam rubber, polyurethane foam rubber, such as polyether polyurethane foam and polyester polyurethane foam, or any other similar material.

Referring now to the example of FIGS. 1 and 2, in some embodiments, an automatic litter and waste separator device 100 may comprise a litter container 11 having a base 12 and four sidewalls 13, 14, 15, 16, which may be coupled together to form a cavity 17. A litter motivator 21 may be coupled to the base 12. The device 100 may be supported above a floor surface 201 by a generally rectangular shaped horizontal dampener 31 which may be coupled to the base 12 and which may separate and vibrationally isolate the litter container 11 and the litter motivator 21 coupled thereto from the floor surface 201.

Turning to the example of FIGS. 3 and 4, another example of an automatic litter and waste separator device 100 according to various embodiments described herein is shown. In this example, the device 100 may comprise a litter container 11 having a base 12 and four sidewalls 13, 14, 15, 16, which may be coupled together to form a cavity 17. A first litter motivator 21A and a second litter motivator 21B may both be coupled to the base 12. The device 100 may be supported above a floor surface 201 by a generally rectangular shaped vertical dampener 33 which may be coupled to the four sidewalls 13, 14, 15, 16, and which may vibrationally isolate the litter container 11 and the litter motivator 21 coupled thereto from the floor surface 201.

Referencing the example of FIGS. 5 and 6, a further example of an automatic litter and waste separator device 100 according to various embodiments described herein is illustrated. In this example, the device 100 may comprise a litter container 11 having a base 12 and four sidewalls 13, 14, 15, 16, which may be coupled together to form a cavity 17. A first litter motivator 21A and a second litter motivator 21B may both be coupled to the base 12. The device 100 may comprise a horizontal dampener 31 which may be coupled to the litter motivators 21A, 21B, and coupled to a vertical dampener 33 which may support the device 100 above a floor surface 201 (FIGS. 1-4). In this manner, the vertical dampener 33 may separate the litter container 11 and the litter motivators 21A, 21B, from the floor surface 201 thereby providing vibrational isolation between the litter motivators 21A, 21B, and the base 12 of the litter container 11 and between the floor surface 201 upon which the device 100 may be placed. The device 100 may further comprise a vertical dampener 33 which may be coupled one or more of the four sidewalls 13, 14, 15, 16, and also to the horizontal dampener 31. The vertical dampener 33 may provide vibrational isolation between the four sidewalls 13, 14, 15, 16, and the horizontal dampener 31, and therefore between the four sidewalls 13, 14, 15, 16, and the floor surface 201 upon which the device 100 may be placed.

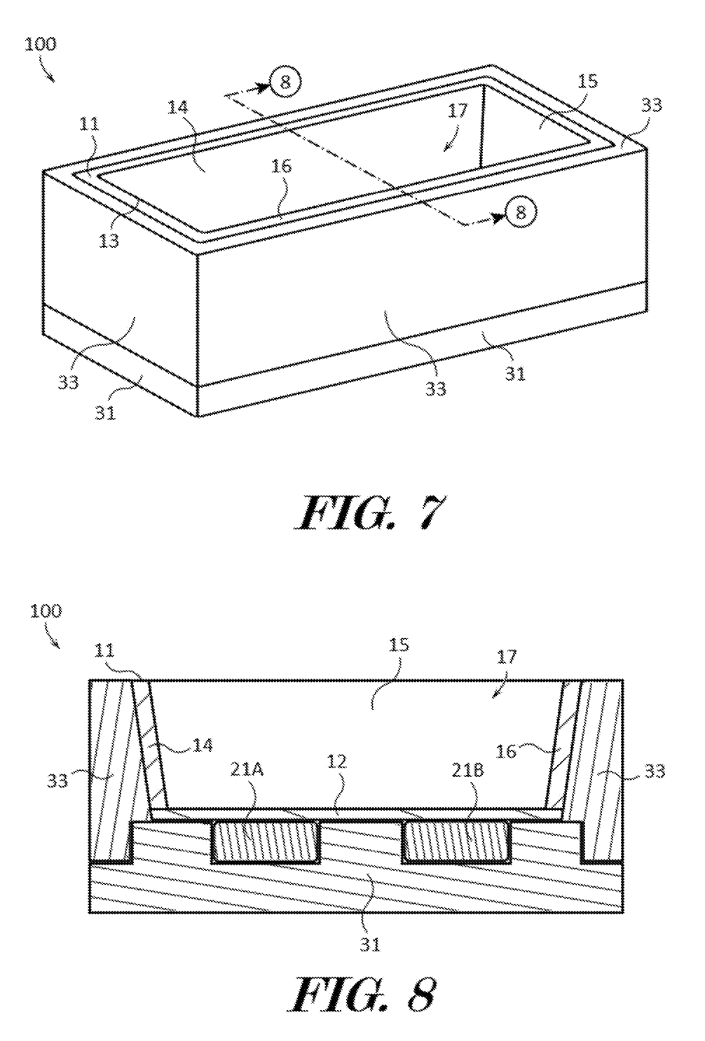

Referring now to FIGS. 7 and 8, still another example of an automatic litter and waste separator device 100 according to various embodiments described herein is depicted. In this example, the device 100 may comprise a litter container 11 having a base 12 and four sidewalls 13, 14, 15, 16, which may be coupled together to form a cavity 17. A first litter motivator 21A and a second litter motivator 21B may both be coupled to the base 12, such as to the base exterior surface 45 (FIG. 9). The device 100 may comprise a horizontal dampener 31 which may be coupled to the litter motivators 21A, 21B, and which may support the device 100 above a floor surface 201 (FIGS. 1-4). Additionally, the horizontal dampener 31 may be coupled to all or portions of the base exterior surface which are not coupled to the litter motivators 21, and the horizontal dampener 31 may also be coupled to the litter motivators 21. In preferred embodiments, a litter motivator 21 which is coupled to the base 12, such as to the base exterior surface 45, may be enclosed or encased by the horizontal dampener 31 as shown in FIG. 8. The horizontal dampener 31 may provide vibrational isolation between the litter motivators 21A, 21B, and therefore between the base 12 of the litter container 11 and the floor surface 201 upon which the device 100 may be placed. The device 100 may further comprise a vertical dampener 33 which may be coupled one or more of the four sidewalls 13, 14, 15, 16, and also to the horizontal dampener 31. The vertical dampener 33 may provide vibrational isolation between the four sidewalls 13, 14, 15, 16, and the horizontal dampener 31, and therefore between the four sidewalls 13, 14, 15, 16, and the floor surface 201 upon which the device 100 may be placed.

FIG. 10 shows a block diagram showing some of the elements of an exemplary automatic litter and waste separator device 100 according to various embodiments described herein. In some embodiments and in the present example, the device 100 can be a digital device that, in terms of hardware architecture, comprises a processing unit 50 which may generally include a processor 51, input/output (I/O) interfaces 52, memory 53, control input 55, and power source 56. It should be appreciated by those of ordinary skill in the art that FIG. 10 depicts the device 100 in an oversimplified manner, and a practical embodiment may include additional components or elements and suitably configured processing logic to support known or conventional operating features that are not described in detail herein. The components and elements (50, 51, 52, 53, 54, 55, 56) are communicatively coupled via a local interface 57. The local interface 57 can be, for example but not limited to, one or more, circuit boards, buses or other wired or wireless connections, as is known in the art. The local interface 57 can have additional elements, which are omitted for simplicity, such as controllers, buffers (caches), drivers, repeaters, and receivers, among many others, to enable communications. Further, the local interface 57 may include address, control, and/or data connections to enable appropriate communications among the aforementioned components.

The processor 51 is a hardware device for executing software instructions. The processor 51 can be any custom made or commercially available processor, a central processing unit (CPU), an auxiliary processor among several processors associated with the processing unit 51 , a semiconductor-based microprocessor (in the form of a microchip or chip set), or generally any device for executing software instructions. When the processing unit 51 is in operation, the processor 51 is configured to execute software stored within the memory 53, to communicate data to and from the memory 53, and to generally control operations of the device 100 pursuant to the software instructions.

The I/O interfaces 52 can be used to receive and/or output information from the device 100. The I/O interfaces 52 can also include, for example, a serial port, a parallel port, a small computer system interface (SCSI), an infrared (IR) interface, a radio frequency (RF) interface, a universal serial bus (USB) interface, one or more sensors, and the like.

The memory 53 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 53 may incorporate electronic, magnetic, optical, and/or other types of storage media. Note that the memory 53 may have a distributed architecture, where various components are situated remotely from one another, but can be accessed by the processor 51. The software in memory 53 can include one or more software programs, each of which includes an ordered listing of executable instructions for implementing logical functions. In the example of FIG. 10, the software in the memory system 53 includes programs 54. The programs 54 may include various applications, add-ons, etc. configured to provide end user functionality with the device 100. In a typical example, the end user typically uses one or more of the programs 54 to control the duration, frequency, time periods, and/or strength of vibrations provided by one or more litter motivators 21A, 21B.

In some embodiments, the device 100 may optionally comprise one or more control inputs 55 that a user may interact with such as turnable control knobs, depressible button type switches, a key pad, slide type switches, rocker type switches, or any other suitable input that may be used to modulate functions of the device 100 such as the duration, frequency, time periods, and/or strength of vibrations provided by one or more litter motivators 21A, 21B. It should be understood that the processing unit 50 and the control inputs 55 are optional components of the device 100 and that the duration, frequency, time periods, and/or strength of vibrations provided by one or more litter motivators 21A, 21B, may be controlled by a processing unit 50 and/or a control input 55.

In some embodiments, the device 100 may optionally comprise a power source 56 which may provide electrical power to any component of the device 100 that may require electrical power, such as to a first litter motivator 21A, an optional second litter motivator 21B, and the like. A power source 56 may comprise a battery, such as a lithium ion battery, nickel cadmium battery, alkaline battery, or any other suitable type of battery, a fuel cell, a capacitor, a super capacitor, or any other type of energy storing and/or electricity releasing device. In further embodiments, a power source 56 may comprise a power cord, kinetic or piezo electric battery charging device, a solar cell or photovoltaic cell, and/or inductive charging or wireless power receiver. In some embodiments, a processing unit 50 may govern power supplied from the power source 56 to a litter motivator 21 as dictated by one or more programs 54. In further embodiments, a control input 55 may govern power supplied from the power source 56 to a litter motivator 21.

While some materials have been provided, in other embodiments, the elements that comprise the device 100 such as the litter container 11, optional horizontal dampener 31, optional vertical dampener 33, and/or any other element discussed herein may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An automatic litter and waste separator device for use on a floor surface, the device comprising:
a. a litter container having a base and a sidewall;
b. a litter motivator coupled to the litter container; and
c. a horizontal dampener which separates the litter container and the litter motivator from the floor surface.

2. The device of claim 1, wherein the litter motivator is coupled to base.

3. The device of claim 1, further comprising a power source.

4. The device of claim 4, further comprising a processing unit, wherein the processing unit governs power supplied from the power source to the litter motivator.

5. The device of claim 1, wherein the horizontal dampener comprises a dampening material selected from the group consisting of elastomer material, visco-elastic polyurethane material, rubber, cork, and foam material.

6. The device of claim 1, wherein the horizontal dampener is coupled to the litter motivator.

7. The device of claim 1, wherein the horizontal dampener is coupled to the base.

8. The device of claim 1, wherein the litter motivator is selected from the group consisting of a long life brushless vibration motor, a coin or pancake vibration motor, an encapsulated vibration motor, an enclosed vibration motor, a pager motor, an eccentric rotating mass motor, a linear resonant actuator, and a printed circuit board mounted vibration motor.

9. The device of claim 1, further comprising a vertical dampener coupled to the sidewall and to the horizontal dampener.

10. The device of claim 1, wherein the base comprises a base exterior surface, wherein the litter motivator is coupled to the base exterior surface, and wherein the horizontal dampener is coupled to the base exterior surface and to the litter motivator.

11. An automatic litter and waste separator device for use on a floor surface, the device comprising:
a. a litter container having a base and a sidewall;
b. a litter motivator coupled to the litter container; and
c. a vertical dampener which separates the litter container and the litter motivator from the floor surface.

12. The device of claim 11, wherein litter motivator is coupled to base.

13. The device of claim 11, further comprising a power source.

14. The device of claim 14 further comprising a processing unit, wherein the processing unit governs power supplied from the power source to the litter motivator.

15. The device of claim 11, wherein the vertical dampener comprises a dampening material selected from the group consisting of elastomer material, visco-elastic polyurethane material, rubber, cork, and foam material.

16. The device of claim 11, wherein the vertical dampener is coupled to the sidewall.

17. The device of claim 11, further comprising a horizontal dampener.

18. The device of claim 18, wherein the vertical dampener is coupled to the horizontal dampener.

19. The device of claim 18, wherein the base comprises a base exterior surface, wherein the litter motivator is coupled to the base exterior surface, and wherein the horizontal dampener is coupled to the base exterior surface and to the litter motivator.

20. The device of claim 11, wherein the litter motivator is selected from the group consisting of a long life brushless vibration motor, a coin or pancake vibration motor, an encapsulated vibration motor, an enclosed vibration motor, a pager motor, an eccentric rotating mass motor, a linear resonant actuator, and a printed circuit board mounted vibration motor.
